(19) United States
(12) Patent Application Publication
(10) Pub. No.: US 2025/0048294 A1
(43) Pub. Date: Feb. 6, 2025

(54) TIMING ADVANCE OFFSET CONFIGURATION

(71) Applicant: QUALCOMM Incorporated, San Diego, CA (US)

(72) Inventors: Shaozhen GUO, Beijing (CN); Mostafa KHOSHNEVISAN, San Diego, CA (US); Fang YUAN, Beijing (CN); Jing SUN, San Diego, CA (US); Xiaoxia ZHANG, San Diego, CA (US); Yan ZHOU, San Diego, CA (US); Tao LUO, San Diego, CA (US)

(21) Appl. No.: 18/717,081

(22) PCT Filed: Feb. 28, 2022
(86) PCT No.: PCT/CN2022/078187

§ 371 Date: Jun. 6, 2024

(51) Int. Cl. H04W 56/00; H04W 72/1268; H04W 80/02

(52) U.S. Cl. CPC H04W 56/0045; H04W 72/1268; H04W 80/02

(57) ABSTRACT

Various aspects of the present disclosure generally relate to wireless communication. In some aspects, a user equipment (UE) may receive information scheduling an uplink resource on a carrier, wherein the carrier is associated with a plurality of timing advance groups and is associated with one or more timing advance offsets for the plurality of timing advance groups. The UE may transmit, using the uplink resource, on the carrier in accordance with the one or more timing advance offsets. Numerous other aspects are described.

### FIELD OF THE DISCLOSURE

Aspects of the present disclosure generally relate to wireless communication and to techniques and apparatuses for timing advance offset configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include receiving information scheduling an uplink resource on a carrier, wherein the carrier is associated with a plurality of timing advance groups and is associated with one or more timing advance offsets for the plurality of timing advance groups. The method may include transmitting, using the uplink resource, on the carrier in accordance with the one or more timing advance offsets.

Some aspects described herein relate to a method of wireless communication performed by a UE. The method may include receiving information identifying a single timing advance offset common to a plurality of carriers. The method may include transmitting, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to a method of wireless communication performed by a network entity. The method may include transmitting information scheduling an uplink resource on a carrier, wherein the carrier is associated with a plurality of timing advance groups and is associated with one or more timing advance offsets for the plurality of timing advance groups. The method may include receiving, using the uplink resource, on the carrier in accordance with the one or more timing advance offsets.

Some aspects described herein relate to a method of wireless communication performed by a network entity. The method may include transmitting information identifying a single timing advance offset common to a plurality of carriers. The method may include receiving, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to a UE for wireless communication. The UE may include a memory and one or more processors coupled to the memory. The one or more processors may be configured to receive information scheduling an uplink resource on a carrier, wherein the carrier is associated with a plurality of timing advance groups and is associated with one or more timing advance offsets for the plurality of timing advance groups. The one or more processors may be configured to transmit, using the uplink resource, on the carrier in accordance with the one or more timing advance offsets.

Some aspects described herein relate to a UE for wireless communication. The UE may include a memory and one or more processors coupled to the memory. The one or more processors may be configured to receive information identifying a single timing advance offset common to a plurality of carriers. The one or more processors may be configured to transmit, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to a network entity for wireless communication. The network entity may include a memory and one or more processors coupled to the memory. The one or more processors may be configured to transmit information scheduling an uplink resource on a carrier, wherein the carrier is associated with a plurality of timing advance groups and is associated with one or more timing advance offsets for the plurality of timing advance groups. The one or more processors may be configured to receive, using the uplink resource, on the carrier in accordance with the one or more timing advance offsets.

Some aspects described herein relate to a network entity for wireless communication. The network entity may include a memory and one or more processors coupled to the memory. The one or more processors may be configured to transmit information identifying a single timing advance offset common to a plurality of carriers. The one or more processors may be configured to receive, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to a non-transitory computer-readable medium that stores a set of instructions for wireless communication by a UE. The set of instructions, when executed by one or more processors of the UE, may cause the UE to receive information scheduling an uplink resource on a carrier, wherein the carrier is associated with a plurality of timing advance groups and is associated with one or more timing advance offsets for the plurality of timing advance groups. The set of instructions, when executed by one or more processors of the UE, may cause the UE to transmit, using the uplink resource, on the carrier in accordance with the one or more timing advance offsets.

Some aspects described herein relate to a non-transitory computer-readable medium that stores a set of instructions for wireless communication by a UE. The set of instructions, when executed by one or more processors of the UE, may cause the UE to receive information identifying a single timing advance offset common to a plurality of carriers. The set of instructions, when executed by one or more processors of the UE, may cause the UE to transmit, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to a non-transitory computer-readable medium that stores a set of instructions for wireless communication by a network entity. The set of instructions, when executed by one or more processors of the network entity, may cause the network entity to transmit information scheduling an uplink resource on a carrier, wherein the carrier is associated with a plurality of timing advance groups and is associated with one or more timing advance offsets for the plurality of timing advance groups. The set of instructions, when executed by one or more processors of the network entity, may cause the network entity to receive, using the uplink resource, on the carrier in accordance with the one or more timing advance offsets.

Some aspects described herein relate to a non-transitory computer-readable medium that stores a set of instructions for wireless communication by a network entity. The set of instructions, when executed by one or more processors of the network entity, may cause the network entity to transmit information identifying a single timing advance offset common to a plurality of carriers. The set of instructions, when executed by one or more processors of the network entity, may cause the network entity to receive, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to an apparatus for wireless communication. The apparatus may include means for receiving information scheduling an uplink resource on a carrier, wherein the carrier is associated with a plurality of timing advance groups and is associated with one or more timing advance offsets for the plurality of timing advance groups. The apparatus may include means for transmitting, using the uplink resource, on the carrier in accordance with the one or more timing advance offsets.

Some aspects described herein relate to an apparatus for wireless communication. The apparatus may include means for receiving information identifying a single timing advance offset common to a plurality of carriers. The apparatus may include means for transmitting, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Some aspects described herein relate to an apparatus for wireless communication. The apparatus may include means for transmitting information scheduling an uplink resource on a carrier, wherein the carrier is associated with a plurality of timing advance groups and is associated with one or more timing advance offsets for the plurality of timing advance groups. The apparatus may include means for receiving, using the uplink resource, on the carrier in accordance with the one or more timing advance offsets.

Some aspects described herein relate to an apparatus for wireless communication. The apparatus may include means for transmitting information identifying a single timing advance offset common to a plurality of carriers. The apparatus may include means for receiving, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of multiple transmit receive point (multi-TRP) communication, in accordance with the present disclosure.

FIGS. 5-6 are diagrams illustrating examples associated with timing advance offset configuration, in accordance with the present disclosure.

FIGS. 7-10 are diagrams illustrating example processes associated with timing advance offset configuration, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

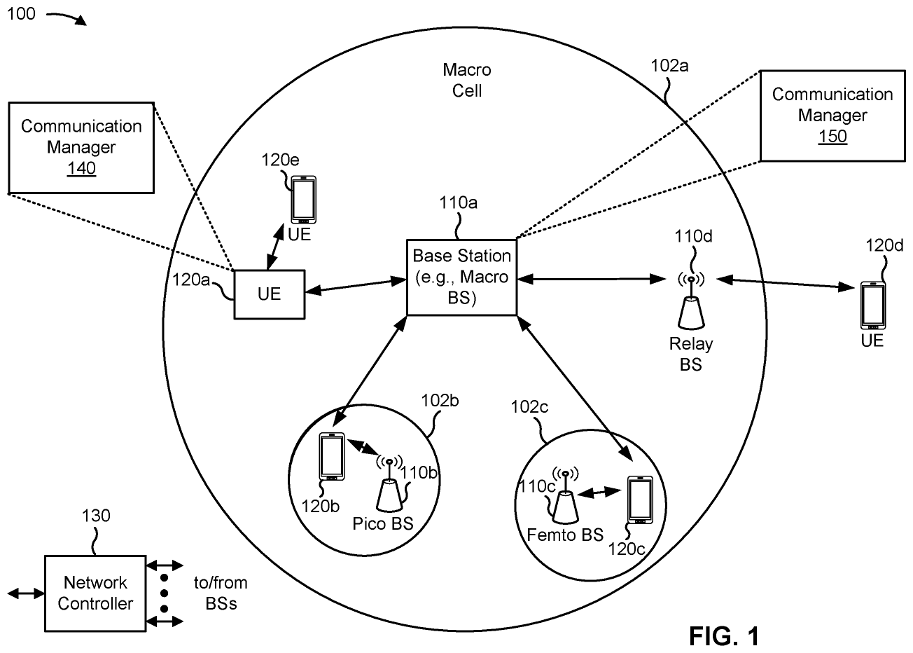

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHZ-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHZ). FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information scheduling an uplink resource on a carrier, wherein the carrier is associated with a plurality of timing advance groups and is associated with one or more timing advance offsets for the plurality of timing advance groups; and transmit, using the uplink resource, on the carrier in accordance with the one or more timing advance offsets. The communication manager 140 may receive information identifying a single timing advance offset common to a plurality of carriers; and transmit, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups. Additionally, or alternatively, the communication manager 140 may perform one or more other operations described herein.

In some aspects, a network entity (e.g., a base station 110) may include a communication manager 150. As described in more detail elsewhere herein, the communication manager 150 may transmit information scheduling an uplink resource on a carrier, wherein the carrier is associated with a plurality of timing advance groups and is associated with one or more timing advance offsets for the plurality of timing advance groups; and receive, using the uplink resource, on the carrier in accordance with the one or more timing advance offsets. The communication manager 150 may transmit information identifying a single timing advance offset common to a plurality of carriers; and receive, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups. Additionally, or alternatively, the communication manager 150 may perform one or more other operations described herein.

As indicated above, FIG. 1 is provided as an example. Other examples may differ from what is described with regard to FIG. 1.

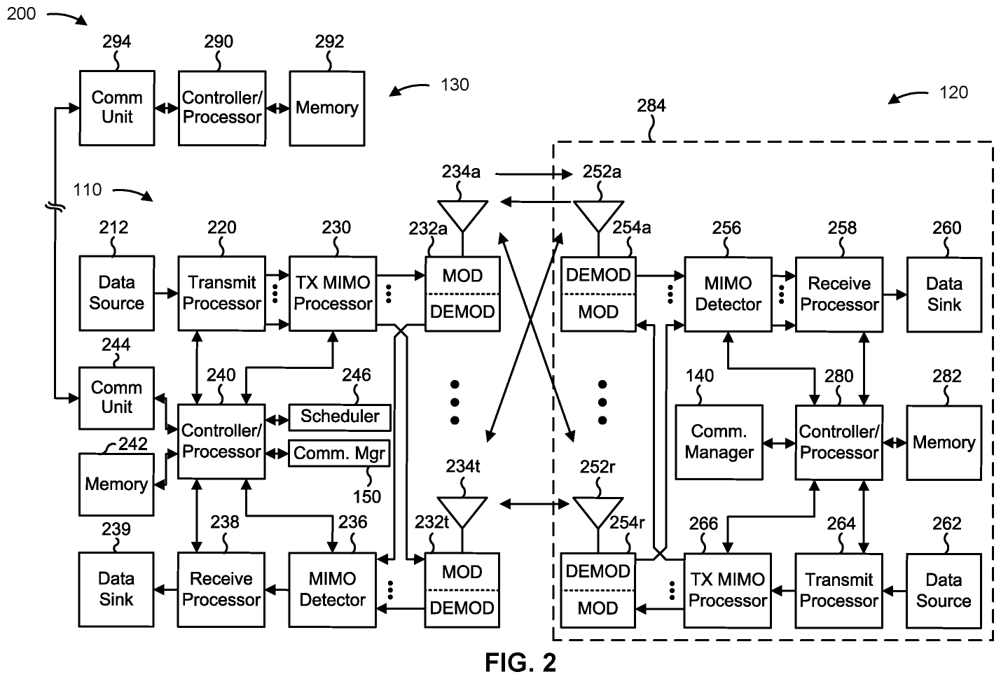

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

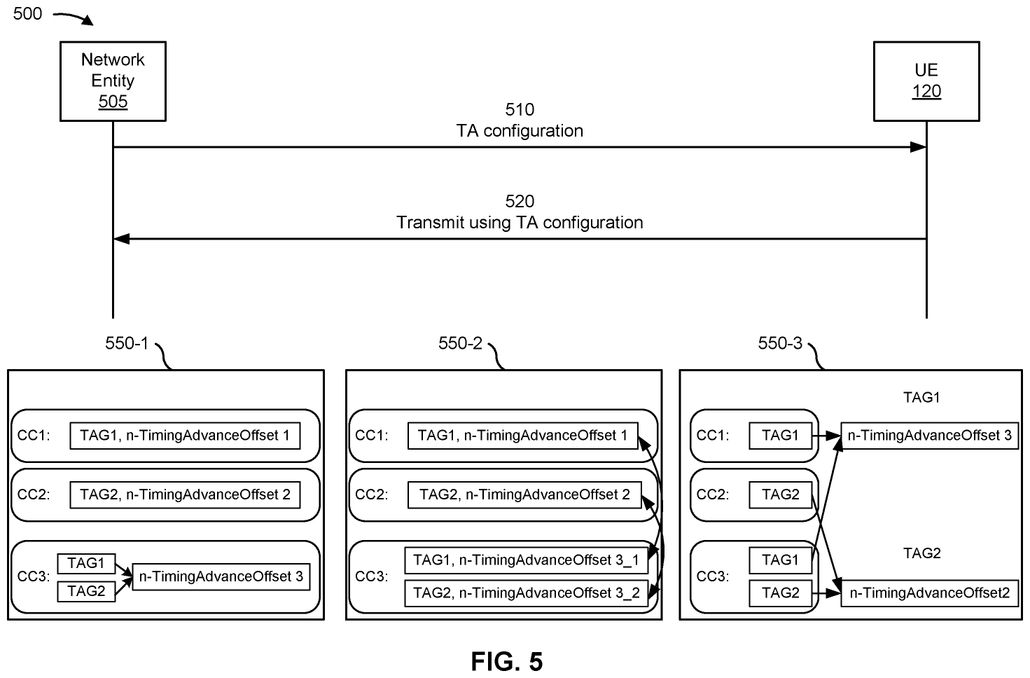

On the uplink, at the UE 120, a transmit processor 264 may receive and process data from a data source 262 and control information (e.g., for reports that include RSRP. RSSI. RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

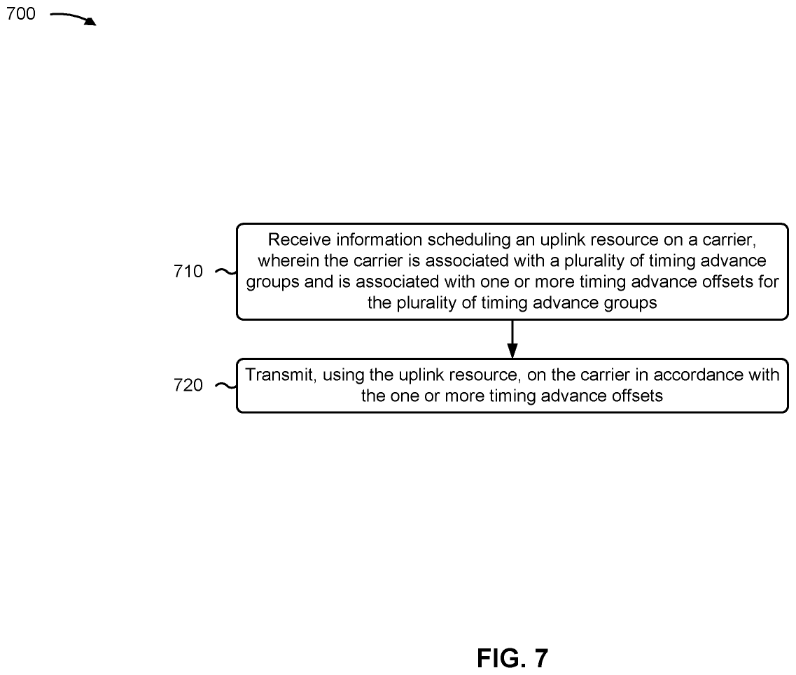

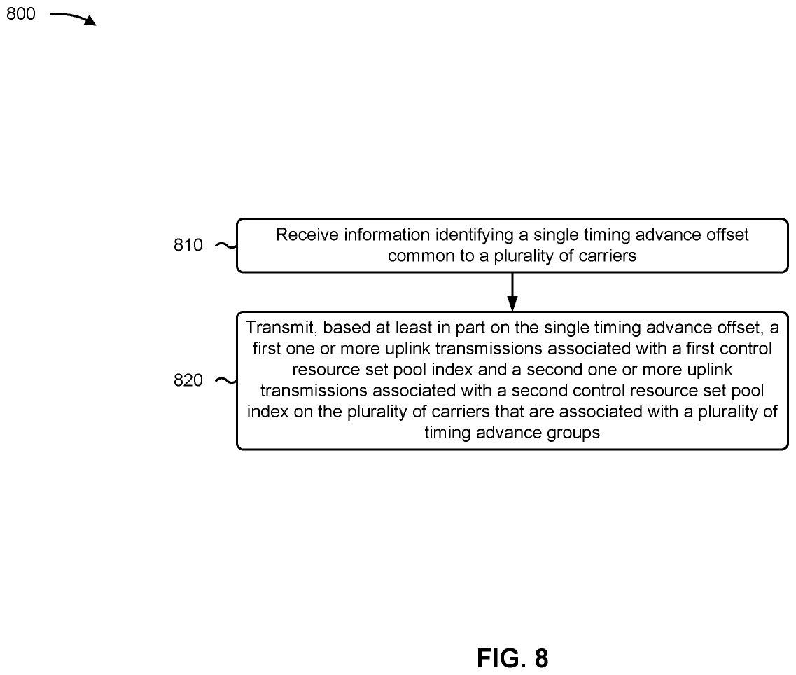

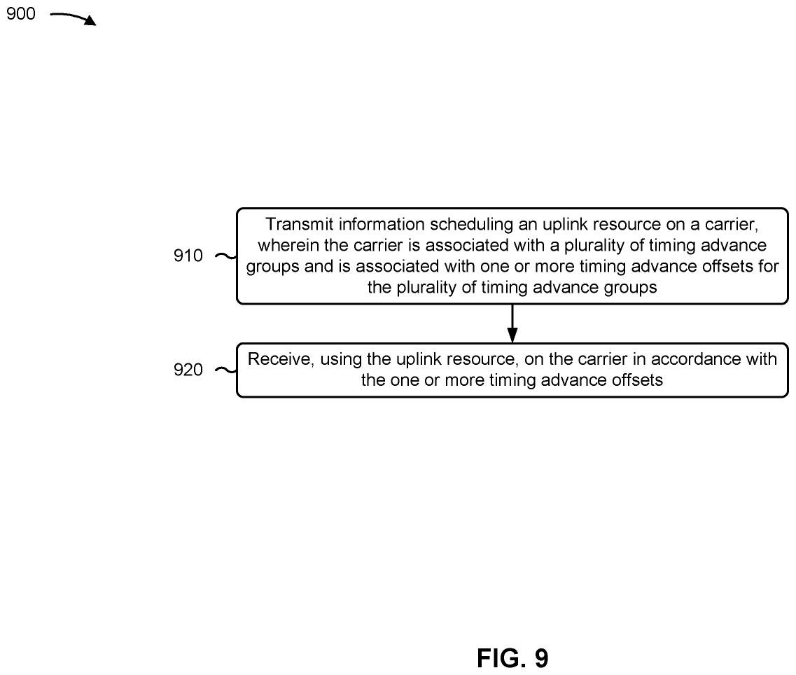

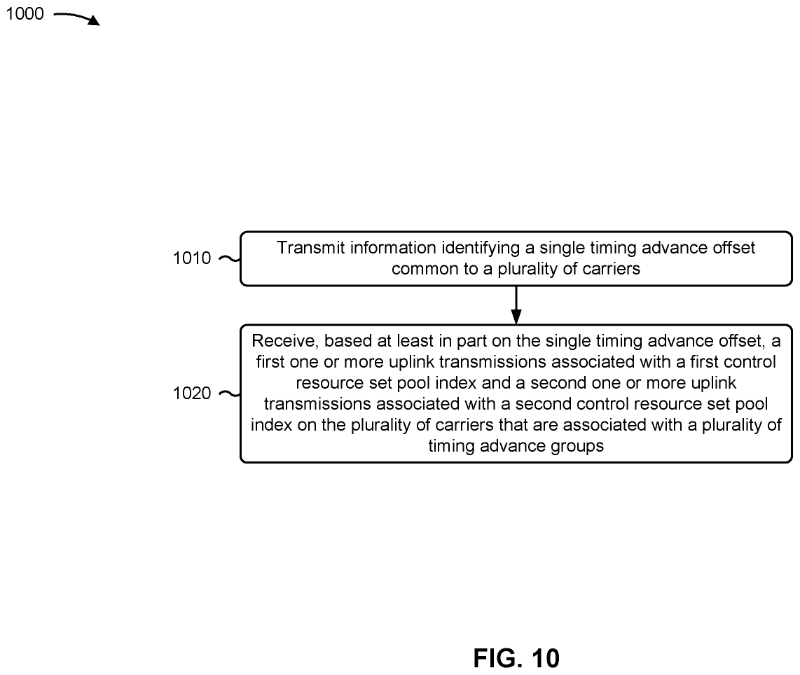

The controller/processor 240 of the base station 110, the controller/processor 280 of the UE 120, and/or any other component(s) of FIG. 2 may perform one or more techniques associated with timing advance offset configuration, as described in more detail elsewhere herein. In some aspects, the network entity or transmit receive point (TRP) described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving information scheduling an uplink resource on a carrier, wherein the carrier is associated with a plurality of timing advance groups and is associated with one or more timing advance offsets for the plurality of timing advance groups; and/or means for transmitting, using the uplink resource, on the carrier in accordance with the one or more timing advance offsets. In some aspects, the UE 120 includes means for receiving information identifying a single timing advance offset common to a plurality of carriers; and/or means for transmitting, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups. The means for the 120 to perform operations described herein may include, for example, one or more of communication manager 140, antenna 252, modem 254, MIMO detector 256, receive processor 258, transmit processor 264. TX MIMO processor 266, controller/processor 280, or memory 282.

In some aspects, a network entity (e.g., a base station 110) includes means for transmitting information scheduling an uplink resource on a carrier, wherein the carrier is associated with a plurality of timing advance groups and is associated with one or more timing advance offsets for the plurality of timing advance groups; and/or means for receiving, using the uplink resource, on the carrier in accordance with the one or more timing advance offsets. In some aspects, the network entity includes means for transmitting information identifying a single timing advance offset common to a plurality of carriers; and/or means for receiving, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups. In some aspects, the means for the network entity to perform operations described herein may include, for example, one or more of communication manager 150, transmit processor 220. TX MIMO processor 230, modem 232, antenna 234. MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

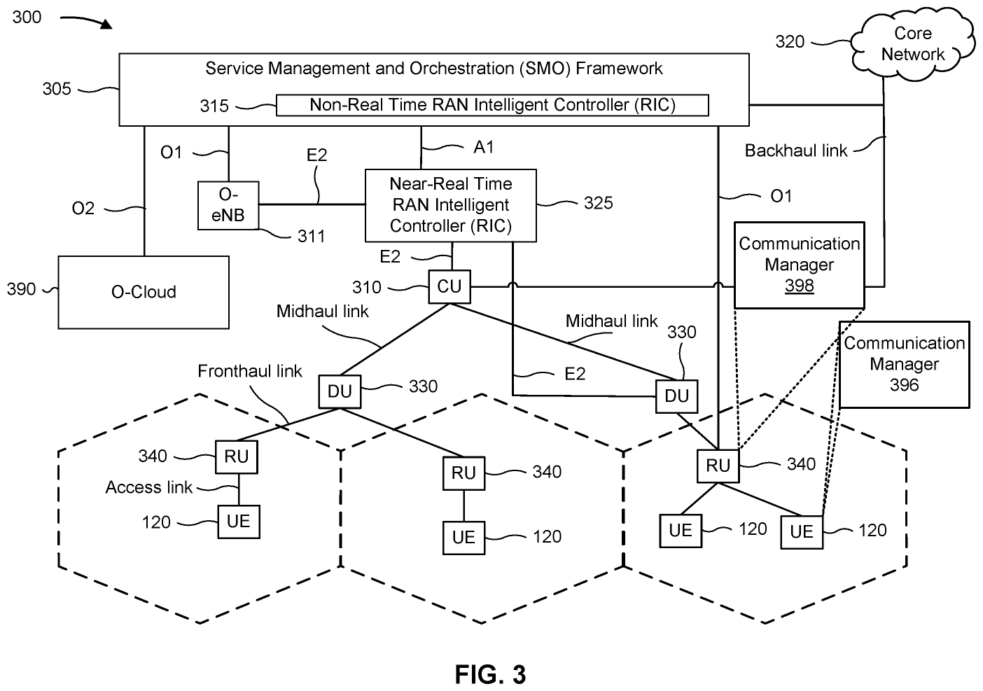

FIG. 3 shows a diagram illustrating an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (RT) (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340. In some implementations, the UE 120 may include a communication manager 396 (e.g., the communication manager 140), which may enable the UE 120 to communicate with other units (e.g., network entities, such as the CUS 310, the DUs 330, or the RUs 340, among other examples). One or more of the units, such as an RU 340, may have a communication manager 398 (e.g., the communication manager 150), which may enable the unit to communicate with the UE 120.

Each of the units, that is, the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), or service data adaptation protocol (SDAP), among other examples. Each control function can be implemented with an interface configured to communicate signals with other control functions hosted by the CU 310. The CU 310 may be configured to handle user plane functionality (Central Unit-User Plane (CU-UP)), control plane functionality (Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, or modulation and demodulation, among other examples) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, or physical random access channel (PRACH) extraction and filtering, among other examples), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310. DUs 330. RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources. Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above. FIG. 3 is provided as an example. Other examples may differ from what is described with regard to FIG. 3.

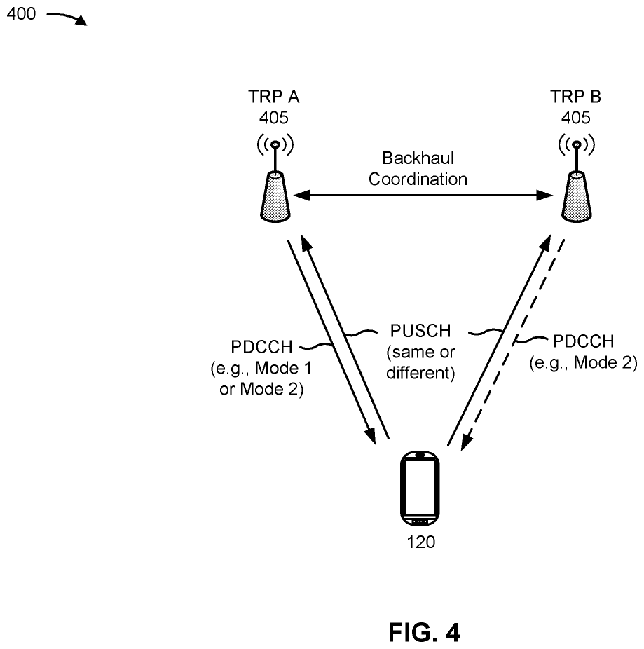

FIG. 4 is a diagram illustrating an example 400 of multi-TRP communication (sometimes referred to as multi-panel communication), in accordance with the present disclosure. As shown in FIG. 4, multiple TRPs 405 may communicate with the same UE 120. A TRP 405 may correspond to one or more of a CU 310, a DU 330, or an RU 340, among other examples as described above in connection with FIG. 3.

The multiple TRPs 405 (shown as TRP A and TRP B) may communicate with the same UE 120 in a coordinated manner (e.g., using coordinated multipoint transmissions) to improve reliability, improve coverage, and/or increase throughput for a serving cell. The TRPs 405 may coordinate such communications via an interface between the TRPs 405 (e.g., a backhaul interface and/or an access node controller). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different quasi-co-location (QCL) relationships (e.g., different transmission configuration indicator (TCI) states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule uplink data communications for physical uplink shared channel (PUSCH) transmissions to multiple TRPs 405. In this case, multiple TRPs 405 (e.g., TRP A and TRP B) may receive PUSCH communications from the UE 120 using resources scheduled by a single downlink control information (DCI) message conveyed using a single PDCCH. A PUSCH communication may be transmitted using a single codeword with different spatial layers for different TRPs 405 (e.g., where one codeword maps to a first set of layers transmitted to a first TRP 405 and maps to a second set of layers transmitted to a second TRP 405). As another example, a PUSCH communication may be transmitted using multiple codewords, where different codewords are transmitted to different TRPs 405 (e.g., using different sets of layers). In either case, different TRPs 405 and the UE 120 may use different QCL relationships (e.g., different TCI states) for different DMRS ports corresponding to different layers. For example, the UE 120 and a first TRP 405 may use a first QCL relationship or a first TCI state for a first set of DMRS ports corresponding to a first set of layers, and the UE 120 and a second TRP 405 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule respective uplink data communications for multiple corresponding PUSCHs (e.g., one PDCCH for each PUSCH). In this case, a first PDCCH may schedule a first codeword to be transmitted to a first TRP 405, and a second PDCCH may schedule a second codeword to be transmitted to a second TRP 405. Furthermore, a first DCI (e.g., transmitted by the first TRP 405) may schedule a first PUSCH communication associated with a first set of DMRS ports with a first QCL relationship (e.g., indicated by a first TCI state) for the first TRP 405, and second DCI (e.g., transmitted by the second TRP 405) may schedule a second PUSCH communication associated with a second set of DMRS ports with a second QCL relationship (e.g., indicated by a second TCI state) for the second TRP 405. In this case. DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state). The second multi-TRP transmission mode may be configured for a bandwidth part (BWP) in a carrier (which may also be referred to as a “component carrier” or “CC”) if two control resource set (CORESET) pool index (CORESETPoolIndex) values are configured for CORESETs of the BWP in the carrier. If a CORESETPoolIndex value is not provided for a CORESET in a BWP in a carrier. UE 120 may be configured to use a default value.

As indicated above. FIG. 4 is provided as an example. Other examples may differ from what is described with respect to FIG. 4.

Each serving cell that provides connectivity for one or more UEs can be associated with a single timing advance group (TAG), which may correspond to a timing advance (TA) value that the serving cell (e.g., a network entity, such as a TRP) and a UE can use for determining a timing of one or more communications. The serving cell may transmit a TA command to indicate an adjustment to a TA value that the serving cell and the UE are using. Additional details regarding TA commands are described with regard to 3GPP Technical Specification (TS) 38.321. Release 16. Version 16.7.0. Each serving cell may be associated with a timing advance offset, which may indicate an amount of offset to apply to timing advance values for a serving cell relative to one or more other serving cell's timing advance values. A network entity may indicate the timing advance offset value by transmitting an n-TimingAdvanceOffset information element (IE). When a UE is not provided with an explicit indication of a timing advance offset value, the UE may be configured to use a default value for the timing advance offset value. Additional details regarding timing advance offset values are described with regard to 3GPP TS 38.133. Release 17. Version 17.4.0.

A network entity may configure a single TAG identifier (TAG-ID) for each serving cell for a UE. In this case, a first timing advance value for transmissions to a first TRP may be based at least in part on an indication in a TA command received by a UE, and a second timing advance value for transmissions to a second TRP may be based at least in part on a timing advance offset applied to the first timing advance value for the first TRP. However, when the UE is configured to communicate on a plurality of uplink carriers, transmitting a plurality of TA commands and information identifying a plurality of timing advance offset values may result in an excessive utilization of network resources.

Accordingly, some aspects described herein may enable a UE to apply a common timing advance offset value across a plurality of carriers associated with, for example, a plurality of TAGs. For example, a UE may apply the same timing advance offset value in a group of carriers even when a first carrier has a different TAG identifier than a second carrier. In this way, the UE enables a reduction in signaling for carriers associated with a single TAG. Additionally, or alternatively, the UE may apply a common timing advance offset value across a plurality of carriers associated with the same TAG. For example, a UE may apply the same timing advance offset value in two carriers, of a group of carriers, with a common TAG ID, but may apply a different timing advance offset value in a third carrier, of the group of carriers, with a different TAG ID.

When a UE is configured with two uplink carriers for a serving cell, the same timing advance offset value can apply to both of the uplink carriers. Similarly, when there are multiple uplink carriers in the same TAG, the UE may be configured to assume the same value for n-TimingAdvanceOffset for each of the multiple uplink carriers. In some cases, a single serving cell may be configured with two TAGs for a multi-DCI, multi-TRP deployment. As an example, a first carrier (C1) may be configured with a first TAG (TAG1) and a first timing advance offset (n-TimingAdvanceOffset1), a second carrier (C2) may be configured with a second TAG (TAG2) and a second timing advance offset (n-TimingAdvanceOffset2), and a third carrier may be configured with two TAGs (e.g., TAG1 and TAG2). In this case, the UE may not have information configuring one or more timing advance offset values for the third carrier that has the two TAGs. This may result in a lack of flexibility and/or a lack of synchronization between communications in a multi-DCI, multi-TRP deployment.

Some aspects described herein enable timing advance offset configuration. For example, a timing advance offset value can be configured on a per carrier basis. Additionally. or alternatively, the timing advance offset value can be configured across carriers such that timing advance offset values are configured on a per TAG basis. Additionally, or alternatively, the timing advance offset value can be configured differently for each TAG in each carrier, such that common TAGs are constrained to having the same value configured. In this way, the UE can determine a timing advance offset value, which enables the UE to determine a timing for communications in a multi-DCI, multi-TRP deployment.

FIG. 5 is a diagram illustrating an example 500 associated with timing advance offset configuration, in accordance with the present disclosure. As shown in FIG. 5, a network entity 505 (e.g., a TRP 405, an RU 340, a DU 330, a CU 310, a base station 110, among other examples) and a UE 120 may communicate with one another.

As shown by reference number 510, the UE 120 may receive timing advance configuration information. For example, the UE 120 may receive information identifying one or more timing advance offset values for one or more carriers. In this case, the UE 120 may receive the information identifying the one or more timing advance offset values in static signaling (e.g., radio resource control (RRC) signaling) or dynamic signaling (e.g., DCI signaling or medium access control (MAC) control element (CE) signaling).

In some aspects, the UE 120 may receive information identifying one or more timing advance offset values configured on a per carrier basis (e.g., three timing advance offset values for three carriers, as shown). For example, as shown by reference number 550-1, UE 120 may receive information identifying a first timing advance offset (n-TimingAdvanceOffset 1) for a first TAG (TAG1) configured for a first carrier, a second timing advance offset (n-TimingAdvanceOffset 2) for a second TAG (TAG2) configured for a second carrier, and a third timing advance offset (n-TimingAdvanceOffset 3) for the first TAG and the second TAG configured for a third carrier. In this case, based at least in part on at least one carrier being configured with two TAGs and a timing advance offset, the network entity 505 configures the UE 120 with the same value for timing advance offsets in any other carrier with either of the two TAGs. In other words, network entity 505 configures n-TimingAdvanceOffset 3, n-TimingAdvanceOffset 2, and n-TimingAdvanceOffset 1 to have a common timing advance offset value, but transmits three different timing advance offset IEs to identify the common timing advance offset value for the three different carriers. Additionally, or alternatively, the network entity 505 may transmit a single timing advance offset IE to identify the common timing advance offset value for the three carriers.

In some aspects, the UE 120 may receive information identifying one or more timing advance offset values configured on a per carrier basis. Additionally, or alternatively, for a serving cell that is configured with two control resource set pool index values and two TAGs, the UE can be configured with two timing advance offset values each associated with a TAG. For example, as shown by reference number 550-2, UE 120 may receive information identifying n-TimingAdvanceOffset 1 for TAG1 for the first carrier, n-TimingAdvanceOffset 2 for TAG2) configured for a second carrier, n-TimingAdvanceOffset 3_1 for TAG1 for a third carrier, and n-TimingAdvanceOffset 3_2 for TAG2 for the third carrier. In other words, the network entity 505 provides 4 different timing advance offset IEs to configure n-TimingAdvanceOffset 1 and n-TimingAdvanceOffset 3_1 to have a first common timing advance offset value for TAG1 in the first carrier and the third carrier, respectively, and to configure n-TimingAdvanceOffset 2 and n-TimingAdvanceOffset 3_2 to have a second common timing advance value for TAG2 in the second carrier and the third carrier, respectively.

Additionally, or alternatively, the network entity 505 may transmit two timing advance offset IEs to identify the first common timing advance offset value and the second common timing advance offset value. For example, as shown by reference number 550-3, network entity 505 may provide information configuring n-TimingAdvanceOffset 1 for TAG1 across all of the carriers (e.g., of a group of scheduled carriers of a PUSCH) and n-TimingAdvanceOffset 2 for TAG2 across all of the carriers.

As shown by reference number 520, the UE 120 may transmit using a timing advance value based at least in part on the timing advance configuration information. For example, UE 120 may transmit on one or more carriers using one or more timing advance offset values received from network entity 505.

As indicated above, FIG. 5 is provided as an example. Other examples may differ from what is described with respect to FIG. 5.

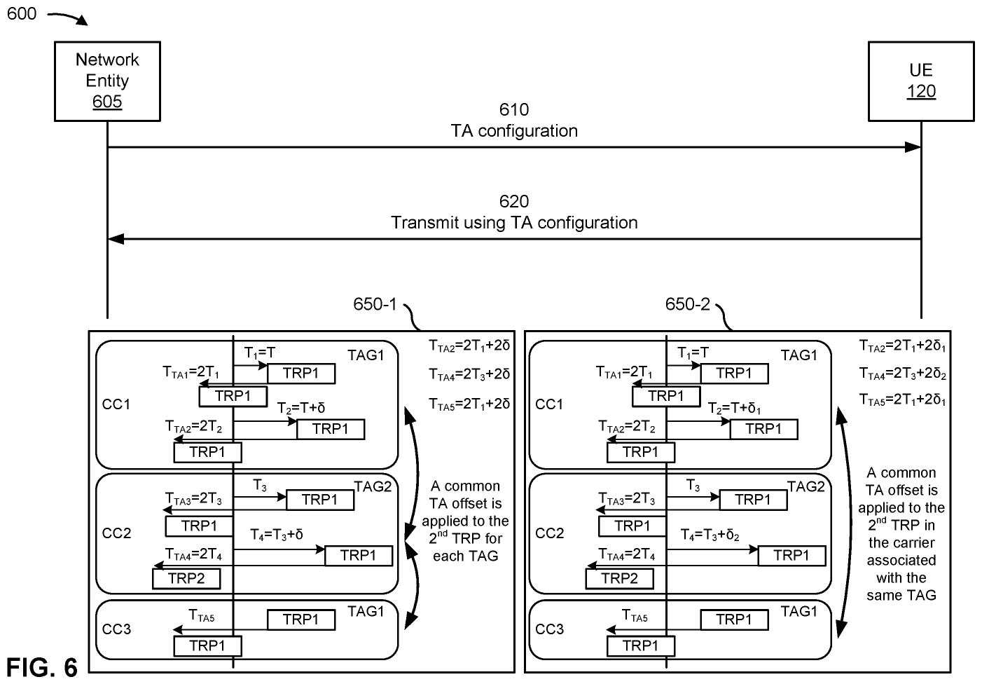

FIG. 6 is a diagram illustrating an example 600 associated with timing advance offset configuration, in accordance with the present disclosure. As shown in FIG. 6, a network entity 605 (e.g., network entity 505, a TRP 405, an RU 340, a DU 330, a CU 310, a base station 110, among other examples) and a UE 120 may communicate with one another.

As shown by reference number 610, the UE 120 may receive timing advance configuration information. For example, the UE 120 may receive information identifying one or more timing advance offset values for one or more carriers. In this case, the UE 120 may receive the information identifying the one or more timing advance offset values in static signaling (e.g., RRC signaling) or dynamic signaling (e.g., DCI signaling or MAC CE signaling).

In some implementations, the UE 120 may receive information identifying the timing advance configuration in a particular type of MAC CE. For example, the UE 120 may receive a MAC CE with a field set to identify a common timing advance command (e.g., a timing advance command applicable across a plurality of carriers and/or a plurality of TAGs). In this case, the MAC CE may include 6 bits to identify the common timing advance offset value and 2 reserve bits in the same octet. For example, a single MAC CE may convey a timing advance command that includes a first octet with 2 bits to identify a TAG ID for the timing advance command and 6 bits to identify a value for the timing advance command and that includes a second octet with 2 reserved bits and 6 bits to identify the common timing advance offset value. In this case, the UE 120 may apply the timing advance command to the identified TAG and may apply the timing advance offset value to derive a timing advance command for the identified TAG, as described in more detail below. Alternatively, the first octet may be included in a first MAC CE (e.g., a TA command MAC CE) and the second octet may be included in a second MAC CE (e.g., a timing advance offset MAC CE). In this case, the second MAC CE includes 2 bits to identify a TAG ID that the common timing advance offset can be applied.

In some implementations, the UE 120 may receive information identifying a common timing advance offset to apply across TAGs. For example, as shown by reference number 650-1, the UE 120 may receive, from the network entity 605, a timing advance offset value ô, that the UE 120 may apply in a first carrier with a first TAG ID, a second carrier with a second TAG ID, and a third carrier with the first TAG ID. In this case, for example, in the first carrier with the first TAG ID, a first transmission to a first TRP may occur T_{TA1}=2×T₁=2T before the start of the corresponding downlink reception, where T_{TA1} is a timing advance applied to a transmission to a first TRP, and a second transmission to a second TRP may occur T_{TA2}=2× T₂=2×(T+δ)=T_{TA1}+2δ before the start of the corresponding downlink reception which has an additional timing advance offset relative to the timing advance for the first TRP in the first carrier, where 2δ is the timing advance offset value. In this way, the UE 120 can use a single timing advance command (T_{TA1}) to determine transmissions to both the first TRP and the second TRP (e.g., by deriving a second timing advance command T_{TA2} using the timing advance offset value). Similarly, in a second carrier with the second TAG ID, a first transmission may occur T_{TA3}=2T₃ before the start of the corresponding downlink reception, where T₃ represents a propagation delay for transmission to the first TRP and T_{TA3} represents a timing advance for the first TRP in the second carrier, and a second transmission may occur T_{TA4}=2×T₄=2×(T₃+δ)=T_{TA3}+2δ before the start of the corresponding downlink reception which has an additional timing advance offset relative to the timing advance for the first TRP in the second carrier. In this way, the UE 120 reuses the timing advance offset value across carriers and across TAGs. Further, in the third carrier with the first TAG ID, the UE 120 transmits to the second TRP T_{TA5}=T_{TA2}=2(T₁+δ) before the start of the corresponding downlink reception. In this way, the UE 120 reuses the timing advance offset value across carriers and in a common TAG (e.g., the same offset value is used in the first TAG on a plurality of carriers).

In some implementations, the UE 120 may receive information identifying a common timing advance offset value that is applicable across carriers, but is TAG specific. For example, the UE 120 may receive a first offset value 281 for the first TAG (e.g., for the first carrier and the third carrier, which each have the first TAG ID) and a second offset value 282 for the second TAG (e.g., for the second carrier). In this case, as shown by reference number 650-2, the first timing advance offset value is a common timing advance offset applied across a plurality of carriers with the same TAG ID (e.g., the first carrier and the third carrier) and the second timing advance offset value is applied across one or more carriers with the same TAG ID (e.g., the second carrier). Although some aspects are described in terms of two TAG IDs and three carriers, other quantities of TAG IDs and/or carriers are possible.

As shown by reference number 620, the UE 120 may transmit using timing advance based at least in part on the timing advance configuration information. For example, the UE 120 may transmit on one or more carriers using one or more timing advance offset values received from network entity 605.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., the UE 120) performs operations associated with timing advance offset configuration.

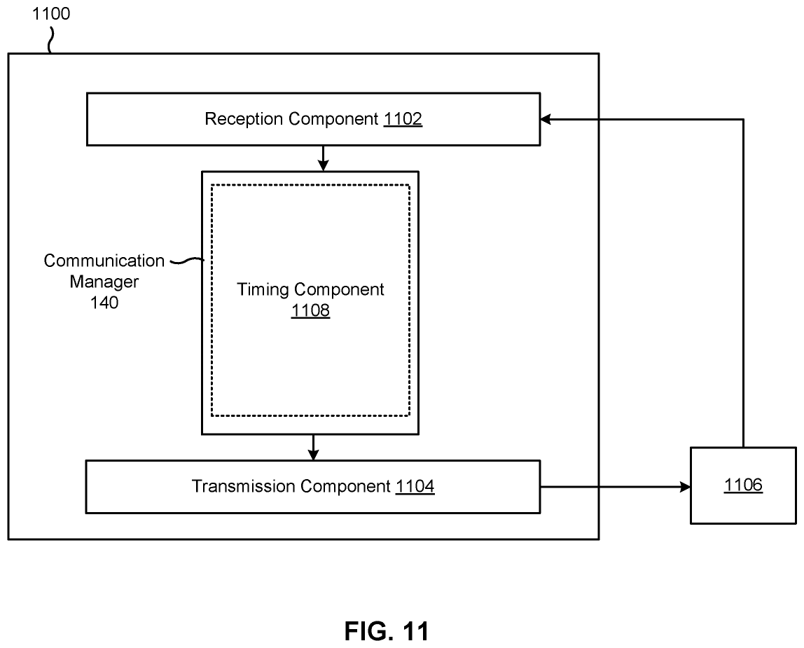

As shown in FIG. 7, in some aspects, process 700 may include receiving information scheduling an uplink resource on a carrier, wherein the carrier is associated with a plurality of timing advance groups and is associated with one or more timing advance offsets for the plurality of timing advance groups (block 710). For example, the UE (e.g., using communication manager 140 and/or reception component 1102, depicted in FIG. 11) may receive information scheduling an uplink resource on a carrier, wherein the carrier is associated with a plurality of timing advance groups and is associated with one or more timing advance offsets for the plurality of timing advance groups, as described above.

As further shown in FIG. 7, in some aspects, process 700 may include transmitting, using the uplink resource, on the carrier in accordance with the one or more timing advance offsets (block 720). For example, the UE (e.g., using communication manager 140 and/or transmission component 1104, depicted in FIG. 11) may transmit, using the uplink resource, on the carrier in accordance with the one or more timing advance offsets, as described above.

Process 700 may include additional aspects, such as any single aspect or any combination of aspects described below and/or in connection with one or more other processes described elsewhere herein.

In a first aspect, the one or more timing advance offsets are configured on a per carrier basis, and the carrier is associated with a single timing advance offset applicable to each of the plurality of timing advance groups.

In a second aspect, alone or in combination with the first aspect, one or more other carriers, which are associated with at least one of the plurality of timing advance groups, are associated with a respective one or more other timing advance offsets, and the one or more timing advance offsets and the one or more other timing advance offsets have a common value.

In a third aspect, alone or in combination with one or more of the first and second aspects, the one or more timing advance offsets are configured on a per carrier basis, and the one or more timing advance offsets include a first timing advance offset associated with a first timing advance group, of the plurality of timing advance groups, and a second timing advance offset associated with a second timing advance group of the plurality of timing advance groups.

In a fourth aspect, alone or in combination with one or more of the first through third aspects, the first timing advance offset and another first timing advance offset associated with a first other carrier, which are each associated with a first common timing advance group, have a first common value, and the second timing advance offset and another second timing advance offset associated with a second other carrier, which are each associated with a second common timing advance group, have a second common value.

In a fifth aspect, alone or in combination with one or more of the first through fourth aspects, the first common value is different from the second common value.

In a sixth aspect, alone or in combination with one or more of the first through fifth aspects, the one or more timing advance offsets are configured on a per timing advance group basis, and each timing advance group is configured with a corresponding timing advance offset.

In a seventh aspect, alone or in combination with one or more of the first through sixth aspects, each first carrier, of a plurality of carriers, associated with a first timing advance group is associated with a first timing advance offset corresponding to the first timing advance group and each second carrier, of the plurality of carriers, associated with a second timing advance group is associated with a second timing advance offset corresponding the second timing advance group.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with timing advance offset configuration.

As shown in FIG. 8, in some aspects, process 800 may include receiving information identifying a single timing advance offset common to a plurality of carriers (block 810). For example, the UE (e.g., using communication manager 140 and/or reception component 1102, depicted in FIG. 11) may receive information identifying a single timing advance offset common to a plurality of carriers, as described above.

As further shown in FIG. 8, in some aspects, process 800 may include transmitting, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups (block 820). For example, the UE (e.g., using communication manager 140 and/or transmission component 1104, depicted in FIG. 11) may transmit, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups, as described above.

Process 800 may include additional aspects, such as any single aspect or any combination of aspects described below and/or in connection with one or more other processes described elsewhere herein.

In a first aspect, a first timing advance value for the first one or more uplink transmissions associated with the first control resource set pool index is based at least in part on a timing advance command for a corresponding timing advance group of the plurality of timing advance groups, and a second timing advance value for the second one or more uplink transmissions associated with the second control resource set pool index is based at least in part on the single timing advance offset common to the plurality of carriers and the first timing advance value of the corresponding timing advance group.

In a second aspect, alone or in combination with the first aspect, receiving the information identifying the single timing advance offset comprises receiving a MAC CE conveying the single timing advance offset common to the plurality of timing advance groups.

In a third aspect, alone or in combination with one or more of the first and second aspects, the single timing advance offset is applied to one or more first transmissions associated with the second control resource set pool index on a first set of carriers, of the plurality of carriers, associated with a first timing advance group identifier, and another timing advance offset is applied to one or more second transmissions associated with the second control resource set pool index on a second set of carriers, of the plurality of carriers, associated with a second timing advance group identifier.

In a fourth aspect, alone or in combination with one or more of the first through third aspects, a first timing advance value for the first one or more uplink transmissions associated with the first control resource set pool index is based at least in part on a timing advance command for a corresponding timing advance group of the plurality of timing advance groups, and a second timing advance value for the second one or more uplink transmissions associated with the second control resource set pool index is based at least in part on the single timing advance offset for the corresponding timing advance group and the first timing advance value of the corresponding timing advance group.

In a fifth aspect, alone or in combination with one or more of the first through fourth aspects, receiving the information identifying the single timing advance offset comprises receiving a first MAC CE conveying the single timing advance offset associated with a timing advance group identifier, and receiving a second MAC CE conveying a timing advance command associated with the timing advance group identifier.

In a sixth aspect, alone or in combination with one or more of the first through fifth aspects, receiving the information identifying the single timing advance offset comprises receiving a single MAC CE conveying the single timing advance offset associated with a timing advance group identifier and conveying a timing advance command associated with the timing advance group identifier.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., base station 110, CU 310, DU 330, RU 340, TRP 405, network entity 505, network entity 605, among other examples) performs operations associated with timing advance offset configuration.

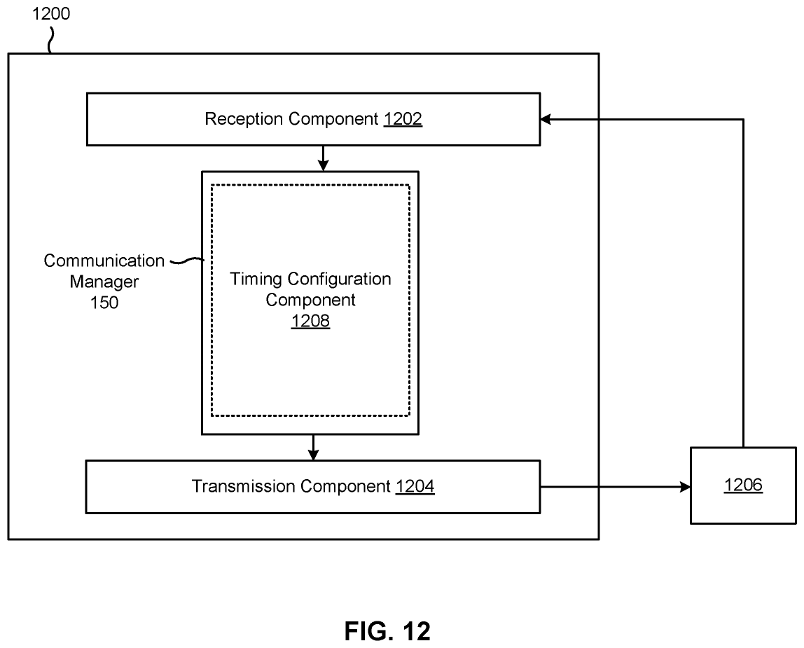

As shown in FIG. 9, in some aspects, process 900 may include transmitting information scheduling an uplink resource on a carrier, wherein the carrier is associated with a plurality of timing advance groups and is associated with one or more timing advance offsets for the plurality of timing advance groups (block 910). For example, the network entity (e.g., using communication manager 150 and/or transmission component 1204, depicted in FIG. 12) may transmit information scheduling an uplink resource on a carrier, wherein the carrier is associated with a plurality of timing advance groups and is associated with one or more timing advance offsets for the plurality of timing advance groups, as described above.

As further shown in FIG. 9, in some aspects, process 900 may include receiving, using the uplink resource, on the carrier in accordance with the one or more timing advance offsets (block 920). For example, the network entity (e.g., using communication manager 150 and/or reception component 1202, depicted in FIG. 12) may receive, using the uplink resource, on the carrier in accordance with the one or more timing advance offsets, as described above.

Process 900 may include additional aspects, such as any single aspect or any combination of aspects described below and/or in connection with one or more other processes described elsewhere herein.

In a first aspect, the one or more timing advance offsets are configured on a per carrier basis, and the carrier is associated with a single timing advance offset applicable to each of the plurality of timing advance groups.

In a second aspect, alone or in combination with the first aspect, one or more other carriers, which are associated with at least one of the plurality of timing advance groups, are associated with a respective one or more other timing advance offsets, and the one or more timing advance offsets and the one or more other timing advance offsets have a common value.

In a third aspect, alone or in combination with one or more of the first and second aspects, the one or more timing advance offsets are configured on a per carrier basis, and the one or more timing advance offsets include a first timing advance offset associated with a first timing advance group, of the plurality of timing advance groups, and a second timing advance offset associated with a second timing advance group of the plurality of timing advance groups.

In a fourth aspect, alone or in combination with one or more of the first through third aspects, the first timing advance offset and another first timing advance offset associated with a first other carrier, which are each associated with a first common timing advance group, have a first common value, and the second timing advance offset and another second timing advance offset associated with a second other carrier, which are each associated with a second common timing advance group, have a second common value.

In a fifth aspect, alone or in combination with one or more of the first through fourth aspects, the first common value is different from the second common value.

In a sixth aspect, alone or in combination with one or more of the first through fifth aspects, the one or more timing advance offsets are configured on a per timing advance group basis, and each timing advance group is configured with a corresponding timing advance offset.

In a seventh aspect, alone or in combination with one or more of the first through sixth aspects, each first carrier, of a plurality of carriers, associated with a first timing advance group is associated with a first timing advance offset corresponding to the first timing advance group and each second carrier, of the plurality of carriers, associated with a second timing advance group is associated with a second timing advance offset corresponding the second timing advance group.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., base station 110, CU 310, DU 330, RU 340, TRP 405, network entity 505, network entity 605, among other examples) performs operations associated with timing advance offset configuration.

As shown in FIG. 10, in some aspects, process 1000 may include transmitting information identifying a single timing advance offset common to a plurality of carriers (block 1010). For example, the network entity (e.g., using communication manager 150 and/or transmission component 1204, depicted in FIG. 12) may transmit information identifying a single timing advance offset common to a plurality of carriers, as described above.

As further shown in FIG. 10, in some aspects, process 1000 may include receiving, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups (block 1020). For example, the network entity (e.g., using communication manager 150 and/or reception component 1202, depicted in FIG. 12) may receive, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups, as described above.

Process 1000 may include additional aspects, such as any single aspect or any combination of aspects described below and/or in connection with one or more other processes described elsewhere herein.

In a first aspect, a first timing advance value for the first one or more uplink transmissions associated with the first control resource set pool index is based at least in part on a timing advance command for a corresponding timing advance group of the plurality of timing advance groups, and a second timing advance value for the second one or more uplink transmissions associated with the second control resource set pool index is based at least in part on the single timing advance offset common to the plurality of carriers and the first timing advance value of the corresponding timing advance group.

In a second aspect, alone or in combination with the first aspect, transmitting the information identifying the single timing advance offset comprises transmitting a MAC CE conveying the single timing advance offset common to the plurality of timing advance groups.

In a third aspect, alone or in combination with one or more of the first and second aspects, the single timing advance offset is applied to one or more first transmissions associated with the second control resource set pool index on a first set of carriers, of the plurality of carriers, associated with a first timing advance group identifier, and another timing advance offset is applied to one or more second transmissions associated with the second control resource set pool index on a second set of carriers, of the plurality of carriers, associated with a second timing advance group identifier.

In a fourth aspect, alone or in combination with one or more of the first through third aspects, a first timing advance value for the first one or more uplink transmissions associated with the first control resource set pool index is based at least in part on a timing advance command for a corresponding timing advance group of the plurality of timing advance groups, and a second timing advance value for the second one or more uplink transmissions associated with the second control resource set pool index is based at least in part on the single timing advance offset for the corresponding timing advance group and the first timing advance value of the corresponding timing advance group.

In a fifth aspect, alone or in combination with one or more of the first through fourth aspects, transmitting the information identifying the single timing advance offset comprises transmitting a first MAC CE conveying the single timing advance offset associated with a timing advance group identifier, and transmitting a second MAC CE conveying a timing advance command associated with the timing advance group identifier.

In a sixth aspect, alone or in combination with one or more of the first through fifth aspects, transmitting the information identifying the single timing advance offset comprises transmitting a single MAC CE conveying the single timing advance offset associated with a timing advance group identifier and conveying a timing advance command associated with the timing advance group identifier.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a timing component 1108, among other examples.

In some aspects, the apparatus 1100 may be configured to perform one or more operations described herein in connection with FIGS. 5-6. Additionally, or alternatively, the apparatus 1100 may be configured to perform one or more processes described herein, such as process 700 of FIG. 7, process 800 of FIG. 8, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive information scheduling an uplink resource on a carrier, wherein the carrier is associated with a plurality of timing advance groups and is associated with one or more timing advance offsets for the plurality of timing advance groups. The transmission component 1104 may transmit, using the uplink resource, on the carrier in accordance with the one or more timing advance offsets. The timing component 1108 may determine a timing for one or more transmissions on one or more carriers in connection with one or more timing advance groups. The reception component 1102 may receive information identifying a single timing advance offset common to a plurality of carriers. The transmission component 1104 may transmit, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a timing configuration component 1208, among other examples.

In some aspects, the apparatus 1200 may be configured to perform one or more operations described herein in connection with FIGS. 5-6. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The transmission component 1204 may transmit information scheduling an uplink resource on a carrier, wherein the carrier is associated with a plurality of timing advance groups and is associated with one or more timing advance offsets for the plurality of timing advance groups. The reception component 1202 may receive, using the uplink resource, on the carrier in accordance with the one or more timing advance offsets. The transmission component 1204 may transmit information identifying a single timing advance offset common to a plurality of carriers. The reception component 1202 may receive, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups. The timing configuration component 1208 may configure a transmission timing for the apparatus 1206 by configuring one or more timing advance commands or timing advance offset values.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving information scheduling an uplink resource on a carrier, wherein the carrier is associated with a plurality of timing advance groups and is associated with one or more timing advance offsets for the plurality of timing advance groups; and transmitting, using the uplink resource, on the carrier in accordance with the one or more timing advance offsets.

Aspect 2: The method of Aspect 1, wherein the one or more timing advance offsets are configured on a per carrier basis, and wherein the carrier is associated with a single timing advance offset applicable to each of the plurality of timing advance groups.

Aspect 3: The method of any of Aspects 1 to 2, wherein one or more other carriers, which are associated with at least one of the plurality of timing advance groups, are associated with a respective one or more other timing advance offsets, and wherein the one or more timing advance offsets and the one or more other timing advance offsets have a common value.

Aspect 4: The method of any of Aspects 1 to 3, wherein the one or more timing advance offsets are configured on a per carrier basis, and wherein the one or more timing advance offsets include a first timing advance offset associated with a first timing advance group, of the plurality of timing advance groups, and a second timing advance offset associated with a second timing advance group of the plurality of timing advance groups.

Aspect 5: The method of Aspect 4, wherein the first timing advance offset and another first timing advance offset associated with a first other carrier, which are each associated with a first common timing advance group, have a first common value, and wherein the second timing advance offset and another second timing advance offset associated with a second other carrier, which are each associated with a second common timing advance group, have a second common value.

Aspect 6: The method of Aspect 5, wherein the first common value is different from the second common value.

Aspect 7: The method of any of Aspects 1 to 6, wherein the one or more timing advance offsets are configured on a per timing advance group basis, and wherein each timing advance group is configured with a corresponding timing advance offset.

Aspect 8: The method of Aspect 7, wherein each first carrier, of a plurality of carriers, associated with a first timing advance group is associated with a first timing advance offset corresponding to the first timing advance group and each second carrier, of the plurality of carriers, associated with a second timing advance group is associated with a second timing advance offset corresponding the second timing advance group.

Aspect 9: A method of wireless communication performed by a user equipment (UE), comprising: receiving information identifying a single timing advance offset common to a plurality of carriers; and transmitting, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Aspect 10: The method of Aspect 9, wherein a first timing advance value for the first one or more uplink transmissions associated with the first control resource set pool index is based at least in part on a timing advance command for a corresponding timing advance group of the plurality of timing advance groups, and wherein a second timing advance value for the second one or more uplink transmissions associated with the second control resource set pool index is based at least in part on the single timing advance offset common to the plurality of carriers and the first timing advance value of the corresponding timing advance group.

Aspect 11: The method of any of Aspects 9 to 10, wherein receiving the information identifying the single timing advance offset comprises: receiving a medium access control (MAC) control element (CE) conveying the single timing advance offset common to the plurality of timing advance groups.

Aspect 12: The method of any of Aspects 9 to 111, wherein the single timing advance offset is applied to one or more first transmissions associated with the second control resource set pool index on a first set of carriers, of the plurality of carriers, associated with a first timing advance group identifier, and wherein another timing advance offset is applied to one or more second transmissions associated with the second control resource set pool index on a second set of carriers, of the plurality of carriers, associated with a second timing advance group identifier.

Aspect 13: The method of any of Aspects 9 to 12, wherein a first timing advance value for the first one or more uplink transmissions associated with the first control resource set pool index is based at least in part on a timing advance command for a corresponding timing advance group of the plurality of timing advance groups, and wherein a second timing advance value for the second one or more uplink transmissions associated with the second control resource set pool index is based at least in part on the single timing advance offset for the corresponding timing advance group and the first timing advance value of the corresponding timing advance group.

Aspect 14: The method of any of Aspects 9 to 13, wherein receiving the information identifying the single timing advance offset comprises: receiving a first medium access control (MAC) control element (CE) conveying the single timing advance offset associated with a timing advance group identifier; and receiving a second MAC CE conveying a timing advance command associated with the timing advance group identifier.

Aspect 15: The method of any of Aspects 9 to 13, wherein receiving the information identifying the single timing advance offset comprises: receiving a single medium access control (MAC) control element (CE) conveying the single timing advance offset associated with a timing advance group identifier and conveying a timing advance command associated with the timing advance group identifier.

Aspect 16: A method of wireless communication performed by a network entity, comprising: transmitting information scheduling an uplink resource on a carrier, wherein the carrier is associated with a plurality of timing advance groups and is associated with one or more timing advance offsets for the plurality of timing advance groups; and receiving, using the uplink resource, on the carrier in accordance with the one or more timing advance offsets.

Aspect 17: The method of Aspect 16, wherein the one or more timing advance offsets are configured on a per carrier basis, and wherein the carrier is associated with a single timing advance offset applicable to each of the plurality of timing advance groups.

Aspect 18: The method of any of Aspects 16 to 17, wherein one or more other carriers, which are associated with at least one of the plurality of timing advance groups, are associated with a respective one or more other timing advance offsets, and wherein the one or more timing advance offsets and the one or more other timing advance offsets have a common value.

Aspect 19: The method of any of Aspects 16 to 18, wherein the one or more timing advance offsets are configured on a per carrier basis, and wherein the one or more timing advance offsets include a first timing advance offset associated with a first timing advance group, of the plurality of timing advance groups, and a second timing advance offset associated with a second timing advance group of the plurality of timing advance groups.

Aspect 20: The method of Aspect 19, wherein the first timing advance offset and another first timing advance offset associated with a first other carrier, which are each associated with a first common timing advance group, have a first common value, and wherein the second timing advance offset and another second timing advance offset associated with a second other carrier, which are each associated with a second common timing advance group, have a second common value.

Aspect 21: The method of Aspect 20, wherein the first common value is different from the second common value.

Aspect 22: The method of any of Aspects 16 to 21, wherein the one or more timing advance offsets are configured on a per timing advance group basis, and wherein each timing advance group is configured with a corresponding timing advance offset.

Aspect 23: The method of Aspect 22, wherein each first carrier, of a plurality of carriers, associated with a first timing advance group is associated with a first timing advance offset corresponding to the first timing advance group and each second carrier, of the plurality of carriers, associated with a second timing advance group is associated with a second timing advance offset corresponding the second timing advance group.

Aspect 24: A method of wireless communication performed by a network entity, comprising: transmitting information identifying a single timing advance offset common to a plurality of carriers; and receiving, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

Aspect 25: The method of Aspect 24, wherein a first timing advance value for the first one or more uplink transmissions associated with the first control resource set pool index is based at least in part on a timing advance command for a corresponding timing advance group of the plurality of timing advance groups, and wherein a second timing advance value for the second one or more uplink transmissions associated with the second control resource set pool index is based at least in part on the single timing advance offset common to the plurality of carriers and the first timing advance value of the corresponding timing advance group.

Aspect 26: The method of any of Aspects 24 to 25, wherein transmitting the information identifying the single timing advance offset comprises: transmitting a medium access control (MAC) control element (CE) conveying the single timing advance offset common to the plurality of timing advance groups.

Aspect 27: The method of any of Aspects 24 to 26, wherein the single timing advance offset is applied to one or more first transmissions associated with the second control resource set pool index on a first set of carriers, of the plurality of carriers, associated with a first timing advance group identifier, and wherein another timing advance offset is applied to one or more second transmissions associated with the second control resource set pool index on a second set of carriers, of the plurality of carriers, associated with a second timing advance group identifier.

Aspect 28: The method of any of Aspects 24 to 27, wherein a first timing advance value for the first one or more uplink transmissions associated with the first control resource set pool index is based at least in part on a timing advance command for a corresponding timing advance group of the plurality of timing advance groups, and wherein a second timing advance value for the second one or more uplink transmissions associated with the second control resource set pool index is based at least in part on the single timing advance offset for the corresponding timing advance group and the first timing advance value of the corresponding timing advance group.

Aspect 29: The method of any of Aspects 24 to 28, wherein transmitting the information identifying the single timing advance offset comprises: transmitting a first medium access control (MAC) control element (CE) conveying the single timing advance offset associated with a timing advance group identifier; and transmitting a second MAC CE conveying a timing advance command associated with the timing advance group identifier.

Aspect 30: The method of any of Aspects 24 to 28, wherein transmitting the information identifying the single timing advance offset comprises: transmitting a single medium access control (MAC) control element (CE) conveying the single timing advance offset associated with a timing advance group identifier and conveying a timing advance command associated with the timing advance group identifier.

Aspect 31: An apparatus for wireless communication at a device, comprising a processor: memory coupled with the processor; and instructions stored in the memory and executable by the processor to cause the apparatus to perform the method of one or more of Aspects 1-8.

Aspect 32: A device for wireless communication, comprising a memory and one or more processors coupled to the memory, the one or more processors configured to perform the method of one or more of Aspects 1-8.

Aspect 33: An apparatus for wireless communication, comprising at least one means for performing the method of one or more of Aspects 1-8.

Aspect 34: A non-transitory computer-readable medium storing code for wireless communication, the code comprising instructions executable by a processor to perform the method of one or more of Aspects 1-8.

Aspect 35: A non-transitory computer-readable medium storing a set of instructions for wireless communication, the set of instructions comprising one or more instructions that, when executed by one or more processors of a device, cause the device to perform the method of one or more of Aspects 1-8.

Aspect 36: An apparatus for wireless communication at a device, comprising a processor: memory coupled with the processor; and instructions stored in the memory and executable by the processor to cause the apparatus to perform the method of one or more of Aspects 9-15.

Aspect 37: A device for wireless communication, comprising a memory and one or more processors coupled to the memory, the one or more processors configured to perform the method of one or more of Aspects 9-15.

Aspect 38: An apparatus for wireless communication, comprising at least one means for performing the method of one or more of Aspects 9-15.

Aspect 39: A non-transitory computer-readable medium storing code for wireless communication, the code comprising instructions executable by a processor to perform the method of one or more of Aspects 9-15.

Aspect 40: A non-transitory computer-readable medium storing a set of instructions for wireless communication, the set of instructions comprising one or more instructions that, when executed by one or more processors of a device, cause the device to perform the method of one or more of Aspects 9-15.

Aspect 41: An apparatus for wireless communication at a device, comprising a processor: memory coupled with the processor; and instructions stored in the memory and executable by the processor to cause the apparatus to perform the method of one or more of Aspects 16-23.

Aspect 42: A device for wireless communication, comprising a memory and one or more processors coupled to the memory, the one or more processors configured to perform the method of one or more of Aspects 16-23.

Aspect 43: An apparatus for wireless communication, comprising at least one means for performing the method of one or more of Aspects 16-23.

Aspect 44: A non-transitory computer-readable medium storing code for wireless communication, the code comprising instructions executable by a processor to perform the method of one or more of Aspects 16-23.

Aspect 45: A non-transitory computer-readable medium storing a set of instructions for wireless communication, the set of instructions comprising one or more instructions that, when executed by one or more processors of a device, cause the device to perform the method of one or more of Aspects 16-23.

Aspect 46: An apparatus for wireless communication at a device, comprising a processor: memory coupled with the processor; and instructions stored in the memory and executable by the processor to cause the apparatus to perform the method of one or more of Aspects 24-30.

Aspect 47: A device for wireless communication, comprising a memory and one or more processors coupled to the memory, the one or more processors configured to perform the method of one or more of Aspects 24-30.

Aspect 48: An apparatus for wireless communication, comprising at least one means for performing the method of one or more of Aspects 24-30.

Aspect 49: A non-transitory computer-readable medium storing code for wireless communication, the code comprising instructions executable by a processor to perform the method of one or more of Aspects 24-30.

Aspect 50: A non-transitory computer-readable medium storing a set of instructions for wireless communication, the set of instructions comprising one or more instructions that, when executed by one or more processors of a device, cause the device to perform the method of one or more of Aspects 24-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive information scheduling an uplink resource on a carrier, wherein the carrier is associated with a plurality of timing advance groups and is associated with one or more timing advance offsets for the plurality of timing advance groups; and
transmit, using the uplink resource, on the carrier in accordance with the one or more timing advance offsets.

2. The UE of claim 1, wherein the one or more timing advance offsets are configured on a per carrier basis, and wherein the carrier is associated with a single timing advance offset applicable to each of the plurality of timing advance groups.

3. The UE of claim 1, wherein one or more other carriers, which are associated with at least one of the plurality of timing advance groups, are associated with a respective one or more other timing advance offsets, and
wherein the one or more timing advance offsets and the one or more other timing advance offsets have a common value.

4. The UE of claim 1, wherein the one or more timing advance offsets are configured on a per carrier basis, and
wherein the one or more timing advance offsets include a first timing advance offset associated with a first timing advance group, of the plurality of timing advance groups, and a second timing advance offset associated with a second timing advance group of the plurality of timing advance groups.

5. The UE of claim 4, wherein the first timing advance offset and another first timing advance offset associated with a first other carrier, which are each associated with a first common timing advance group, have a first common value, and
wherein the second timing advance offset and another second timing advance offset associated with a second other carrier, which are each associated with a second common timing advance group, have a second common value.

6. The UE of claim 5, wherein the first common value is different from the second common value.

7. The UE of claim 1, wherein the one or more timing advance offsets are configured on a per timing advance group basis, and
wherein each timing advance group is configured with a corresponding timing advance offset.

8. The UE of claim 7, wherein each first carrier, of a plurality of carriers, associated with a first timing advance group is associated with a first timing advance offset corresponding to the first timing advance group and each second carrier, of the plurality of carriers, associated with a second timing advance group is associated with a second timing advance offset corresponding the second timing advance group.

9. A user equipment (UE) for wireless communication, comprising:
a memory; and
one or more processors, coupled to the memory, configured to:
receive information identifying a single timing advance offset common to a plurality of carriers; and
transmit, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

10. The UE of claim 9, wherein a first timing advance value for the first one or more uplink transmissions associated with the first control resource set pool index is based at least in part on a timing advance command for a corresponding timing advance group of the plurality of timing advance groups, and
wherein a second timing advance value for the second one or more uplink transmissions associated with the second control resource set pool index is based at least in part on the single timing advance offset common to the plurality of carriers and the first timing advance value of the corresponding timing advance group.

11. The UE of claim 9, wherein the one or more processors, to receive the information identifying the single timing advance offset, are configured to:
receive a medium access control (MAC) control element (CE) conveying the single timing advance offset common to the plurality of timing advance groups.

12. The UE of claim 9, wherein the single timing advance offset is applied to one or more first transmissions associated with the second control resource set pool index on a first set of carriers, of the plurality of carriers, associated with a first timing advance group identifier, and
wherein another timing advance offset is applied to one or more second transmissions associated with the second control resource set pool index on a second set of carriers, of the plurality of carriers, associated with a second timing advance group identifier.

13. The UE of claim 9, wherein a first timing advance value for the first one or more uplink transmissions associated with the first control resource set pool index is based at least in part on a timing advance command for a corresponding timing advance group of the plurality of timing advance groups, and
wherein a second timing advance value for the second one or more uplink transmissions associated with the second control resource set pool index is based at least in part on the single timing advance offset for the corresponding timing advance group and the first timing advance value of the corresponding timing advance group.

14. The UE of claim 9, wherein the one or more processors, to receive the information identifying the single timing advance offset, are configured to:
receive a first medium access control (MAC) control element (CE) conveying the single timing advance offset associated with a timing advance group identifier; and
receive a second MAC CE conveying a timing advance command associated with the timing advance group identifier.

15. The UE of claim 9, wherein the one or more processors, to receive the information identifying the single timing advance offset, are configured to:
receive a single medium access control (MAC) control element (CE) conveying the single timing advance offset associated with a timing advance group identifier and conveying a timing advance command associated with the timing advance group identifier.

16. A network entity for wireless communication, comprising:
a memory; and
one or more processors, coupled to the memory, configured to:
transmit information scheduling an uplink resource on a carrier, wherein the carrier is associated with a plurality of timing advance groups and is associated with one or more timing advance offsets for the plurality of timing advance groups; and
receive, using the uplink resource, on the carrier in accordance with the one or more timing advance offsets.

17. The network entity of claim 16, wherein the one or more timing advance offsets are configured on a per carrier basis, and wherein the carrier is associated with a single timing advance offset applicable to each of the plurality of timing advance groups.

18. The network entity of claim 16, wherein one or more other carriers, which are associated with at least one of the plurality of timing advance groups, are associated with a respective one or more other timing advance offsets, and
wherein the one or more timing advance offsets and the one or more other timing advance offsets have a common value.

19. The network entity of claim 16, wherein the one or more timing advance offsets are configured on a per carrier basis, and
wherein the one or more timing advance offsets include a first timing advance offset associated with a first timing advance group, of the plurality of timing advance groups, and a second timing advance offset associated with a second timing advance group of the plurality of timing advance groups.

20. The network entity of claim 19, wherein the first timing advance offset and another first timing advance offset associated with a first other carrier, which are each associated with a first common timing advance group, have a first common value, and
wherein the second timing advance offset and another second timing advance offset associated with a second other carrier, which are each associated with a second common timing advance group, have a second common value.

21. The network entity of claim 20, wherein the first common value is different from the second common value.

22. The network entity of claim 16, wherein the one or more timing advance offsets are configured on a per timing advance group basis, and
wherein each timing advance group is configured with a corresponding timing advance offset.

23. The network entity of claim 22, wherein each first carrier, of a plurality of carriers, associated with a first timing advance group is associated with a first timing advance offset corresponding to the first timing advance group and each second carrier, of the plurality of carriers, associated with a second timing advance group is associated with a second timing advance offset corresponding the second timing advance group.

24. A network entity for wireless communication, comprising:
a memory; and
one or more processors, coupled to the memory, configured to:
transmit information identifying a single timing advance offset common to a plurality of carriers; and
receive, based at least in part on the single timing advance offset, a first one or more uplink transmissions associated with a first control resource set pool index and a second one or more uplink transmissions associated with a second control resource set pool index on the plurality of carriers that are associated with a plurality of timing advance groups.

25. The network entity of claim 24, wherein a first timing advance value for the first one or more uplink transmissions associated with the first control resource set pool index is based at least in part on a timing advance command for a corresponding timing advance group of the plurality of timing advance groups, and
wherein a second timing advance value for the second one or more uplink transmissions associated with the second control resource set pool index is based at least in part on the single timing advance offset common to the plurality of carriers and the first timing advance value of the corresponding timing advance group.

26. The network entity of claim 24, wherein the one or more processors, to transmit the information identifying the single timing advance offset, are configured to:
transmit a medium access control (MAC) control element (CE) conveying the single timing advance offset common to the plurality of timing advance groups.

27. The network entity of claim 24, wherein the single timing advance offset is applied to one or more first transmissions associated with the second control resource set pool index on a first set of carriers, of the plurality of carriers, associated with a first timing advance group identifier, and
wherein another timing advance offset is applied to one or more second transmissions associated with the second control resource set pool index on a second set of carriers, of the plurality of carriers, associated with a second timing advance group identifier.

28. The network entity of claim 24, wherein a first timing advance value for the first one or more uplink transmissions associated with the first control resource set pool index is based at least in part on a timing advance command for a corresponding timing advance group of the plurality of timing advance groups, and
wherein a second timing advance value for the second one or more uplink transmissions associated with the second control resource set pool index is based at least in part on the single timing advance offset for the corresponding timing advance group and the first timing advance value of the corresponding timing advance group.

29. The network entity of claim 24, wherein the one or more processors, to transmit the information identifying the single timing advance offset, are configured to:
transmit a first medium access control (MAC) control element (CE) conveying the single timing advance offset associated with a timing advance group identifier; and
transmit a second MAC CE conveying a timing advance command associated with the timing advance group identifier.

30. The network entity of claim 24, wherein the one or more processors, to transmit the information identifying the single timing advance offset, are configured to:
transmit a single medium access control (MAC) control element (CE) conveying the single timing advance offset associated with a timing advance group identifier and conveying a timing advance command associated with the timing advance group identifier.
